(19) United States
(12) Patent Application Publication
(10) Pub. No.: US 2026/0149800 A1
(43) Pub. Date: May 28, 2026

(54) SYSTEMS AND METHODS FOR ENHANCED BLOCK PREDICTION

(71) Applicant: Agora Lab, Inc., Santa Clara, CA (US)

(72) Inventor: Wei Dai, Shanghai (CN)

(21) Appl. No.: 18/961,076

(22) Filed: Nov. 26, 2024

(51) Int. Cl. H04N 19/105; H04N 19/159; H04N 19/176; H04N 19/86

(52) U.S. Cl. CPC H04N 19/105; H04N 19/159; H04N 19/176; H04N 19/86

(57) ABSTRACT

Systems and methods for enhanced block prediction for video compression are provided. In some embodiments, the methods and systems for enhanced block prediction initially predict pixels in a video frame to generate predicted blocks. Predicting the pixels includes one or both of an inter prediction and an intra prediction. A weighted combination of the inter prediction and the intra prediction may be used when both prediction methods are employed. After prediction a deep neural network is applied to enhance prediction of the predicted blocks and neighboring reconstructed pixels. The system may determine a number of reconstructed pixels and transmit the number to a decoder. The enhanced prediction may be subtracted from the video frame and then further processed. A determination may be made if blocking artifacts are present, and the system may filter boundaries of the predicted pixels and the neighboring reconstructed pixels.

### BACKGROUND

The present invention relates in general to the field of video compression, and more specifically to methods, computer programs and systems for enhanced block prediction.

Video compression standards are designed to enable reduced bandwidth and size of video content, while maintaining high levels of video quality. Current High Efficiency Video Coding (HEVC) is a video compression standard that offers significant data compression as compared against Advanced Video Coding (AVC) with comparable levels of video quality at the same or similar bit rate. HEVC uses both integer discrete cosine transform (DCT) with varied block sizes, and discrete sine transform (DST) with 4×4 block sizes. Essentially, the standard compares different parts of a frame of the video to find areas that are redundant both within a single frame and between consecutive frames. Redundant areas are then replaced with short descriptions instead of the original pixels.

In block based video coding, the system first divides the video into a multitude of blocks, which may be referred to as the largest coding unit (LCU) or macroblock (MB). Each LCU may be partitioned into smaller blocks for further prediction and reconstruction.

Generally, each block is predicted for a particular frame using either (or both) of inter prediction and intra prediction. Intra prediction uses reconstructed information in the current frame to predict information of the current block. In contrast, inter prediction will use other encoded frame information to reconstruct the information of the current block.

Regardless of whether inter prediction or intra prediction is utilized, there is the possibility of prediction errors and artifacts being generated, especially at block boundaries. These errors and artifacts may diminish the viewing experience of the video, in some extreme cases. Reduction in the degree of prediction/compression will decrease the quantity and severity of these errors, however, reducing compression increases bitrates and may introduce jitter or latency when streaming the video.

Given that there is great value in reducing blocking prediction errors and artifacts while maintaining low bitrates, there is a significant need for alternative methodologies to improve video quality at low bitrates. As such, systems and methods of enhanced block prediction are provided.

### SUMMARY

The present systems and methods relate to video compression, and particularly to enhanced block prediction when video coding. Such systems and methods enable reduced errors in block prediction while maintaining low bitrates in the coded video frames.

In some embodiments, the methods and systems for enhanced block prediction initially predict pixels in a video frame to generate predicted blocks. Predicting the pixels includes one or both of an inter prediction and an intra prediction. A weighted combination of the inter prediction and the intra prediction may be used when both prediction methods are employed. Intra prediction includes angular prediction, intra block copy and palette mode operation. Inter prediction includes block partitioning, un-directional prediction and bi-directional prediction.

After prediction a deep neural network is applied to enhance prediction of the predicted blocks and neighboring reconstructed pixels. The system may determining a number of reconstructed pixels and transmit the number to a decoder. The enhanced prediction may be subtracted from the video frame and then further processed.

In some cases, a determination may be made if blocking artifacts are present. If they are, the system may filter boundaries of the predicted pixels and the neighboring reconstructed pixels, as well as filtering a boundary of the predicted blocks. The filters may be low pass filters. Lastly, the system may select an enhancement from a predefined set of enhancements based on current pixels and transmitting the selected enhancement to the decoder.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example block diagrams of a system for encoding and transmitting video content, in accordance with some embodiment;

FIG. 2 is an example block diagram for the logical stages taken when coding video, in accordance with some embodiments;

FIGS. 3 and 4 are example illustrations of predicted pixels, in accordance with some embodiments;

FIG. 5 is a flow diagram for an example process of block prediction when coding a video, in accordance with some embodiments;

FIG. 6 is a flow diagram for an example sub-process of pixel prediction, in accordance with some embodiments;

FIG. 7 is a flow diagram for an example sub-process of intra prediction of blocks, in accordance with some embodiments;

FIG. 8 is a flow diagram for an example sub-process of inter prediction of blocks, in accordance with some embodiments;

FIGS. 9A and 9B are flow diagrams for alternative example sub-process of prediction enhancement, in accordance with some embodiments; and

FIGS. 10A and 10B are illustrations of computer systems capable of implementing the intelligent quantization, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

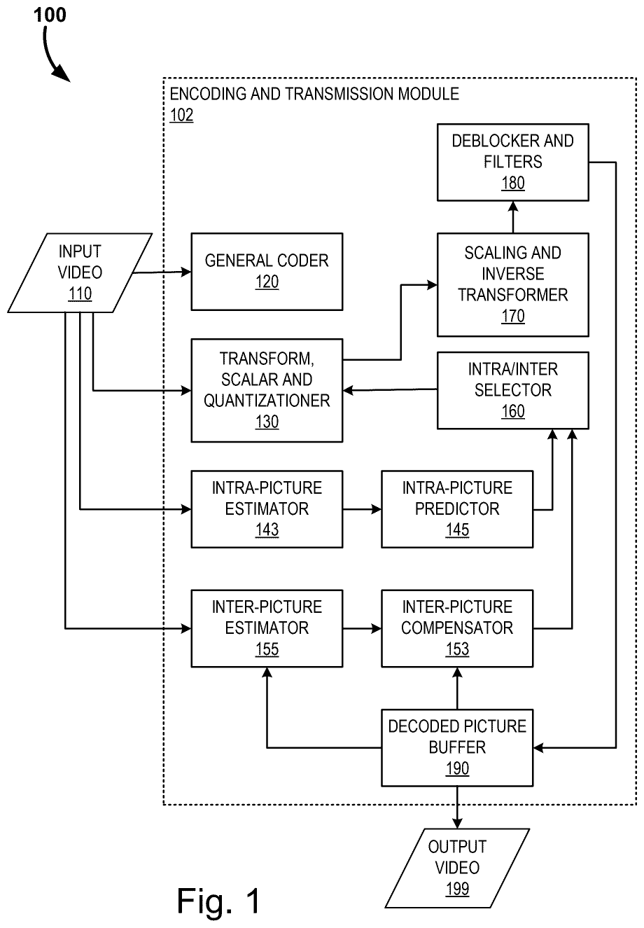

The present invention relates to systems and methods for enhancement of block prediction when coding video content. To facilitate discussions, FIG. 1 is an example of a system for High Efficiency Video Coding (HEVC), shown generally at 100. Coding standards are designed to achieve the highest coding efficiency possible. Coding efficiency is the ability to encode video at a minimized bitrate while achieving a quality threshold. The encoder system 102 splits an inbound picture into block shaped regions for a first picture frame, or the first frame of a random-access point using intra-picture prediction. Intra picture prediction is where prediction of blocks/pixels in the given frame is predicted by using other pixels within the same frame. After the first frame is predicted using intra-picture prediction, the other frames may be predicted using inter-picture prediction techniques. Inter-picture prediction is the prediction of block content based upon the adjacent frame data. After prediction methods are finished, the picture goes through loop filters and the final picture representation is stored in a decoded picture buffer. Images stored in the decoded picture buffer are available for use to predict yet other pictures.

In this system an input video 110 is received by a number of sub-components of the encoding and transmission module 102. These sub components include a general coder 120 and transform, scalar and quantizationer 130, intra-picture estimator 143 and an inter-picture estimator 155. The general coder 120 generates general control data, which is provided to the header formatting and CABAC to incorporate into the coded bitstream. General control data is also provided to the transform, scalar and quantizationer 130, the intra-picture estimator 143, and the inter-picture estimator 155 (not illustrated).

Transform, scalar and quantizationer 130 performs scaling and transform functions on the input video frame and provided output as quantized transform coefficients to the header formatting and a context-adaptive binary arithmetic coding (CABAC) algorithm to incorporate into the coded bitstream. Output is also provided to the scaling and inverse transformer 170. Transform units of various sizes may be used to code the prediction residuals. These transform units may be transformed using discrete cosine transforms or discrete sine transforms. The scaling and inverse transformer 170 in turn provides output to the deblocker and filtering module 180, as well as the intra-picture estimator 143 and intra-picture predictor 145.

The intra-picture estimator 143 uses a variety of prediction algorithms to estimate pixel values from neighboring pixels within the same frame. Output from the intra-picture estimator 143 is provided to an intra-picture predictor 145 which consumes the estimations and generates a prediction of the pixels of interest. Conversely, an inter-picture estimator 155 received adjacent frame data from a decoded picture buffer 190 and estimates motion between one frame to an adjacent frame. Output of the motion estimation is provided to the inter-picture compensator 153 as well as the header formatting and CABAC to incorporate into the coded bitstream (not illustrated).

The inter-picture compensator 153 generates motion compensation information. A selector 160 picks between the intra-picture predicted image data and the inter-picture motion compensated data. This information is fed back to the transform, scalar and quantizationer 130 and the deblocker and filtering module 180 (not illustrated).

The deblocker and filtering module 180 generates filtering control data, which is provided to the header formatting and CABAC to incorporate into the coded bitstream (not illustrated). Deblocked and filtered data is also provided to the decoded picture buffer 190. Output of the decoded picture buffer 190 includes the output video 199.

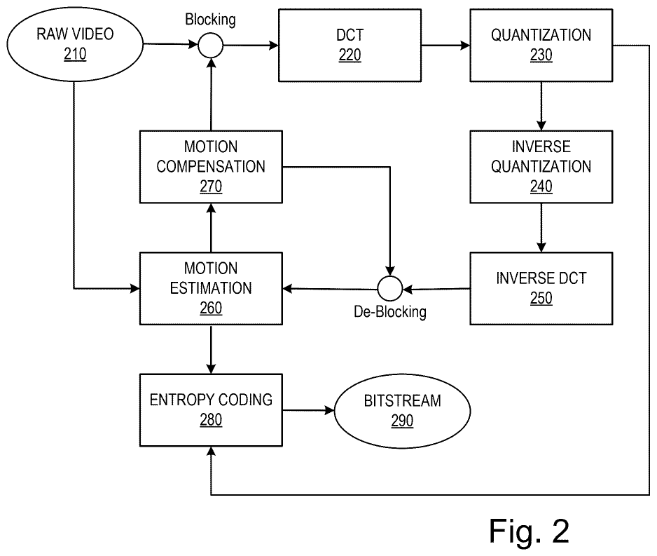

Turning to FIG. 2, a block diagram is provided for the logical frow and transformation of data for the generation of a bitstream 290 from a raw video 210. Initially, the raw video 210 is subjected to blocking. Blocking includes dividing the frame into blocks in one or more sizes. In some embodiments, the blocks range in size from 4×4 to 64×64 pixels. Next a two-dimensional discrete cosine transform (DCT) 220 is applied to each block. DCT significantly reduces the amount of memory and bandwidth of the compressed video. DCT 220 is applied to each frame. Both intra-coding and inter-coding, DCT 220 is calculated on residual values.

After DCT 220 the output is provided to quantization module 230. The quantization scale code is divided element-wise by a quantization matrix and rounds each resultant element. A quantization parameter determines the step size for associating the transformed coefficients with a finite set of steps. The residual blocks are next reconstructed by inverse quantization 240 and inverse DCT 250 respectively. The resulting residual blocks may be reassembled in a de-blocking function with feedback from the motion compensator 270 which performs prediction generation.

Motion estimation 260 utilizes the de-blocked output, as well as the raw video 210 in order to encode one frame in terms of another. Motion estimation 260 encodes the frame data by modified forms of another adjacent frame(s). The goal of motion estimation is to find the best match between regions in the two adjacent frames. The input of motion estimation is macroblocks and search areas. The motion estimation 260 performs block motion estimation which computes motion vectors (MVs) using search algorithms. The most basic search method is using the full search algorithm which processes all pixels in the search range to find the best block matching via a cost function. The output of the motion estimation is provided to motion compensator 270 with in turn is used in the blocking process. Additionally, output from the motion estimation, as well as output from the quantization step, is provided to an entropy coder 280.

The entropy coder 280 is a lossless data compression scheme. It creates and assigns a unique prefix code to each unique symbol in the input. Entropy coding is executed on the quantization results from each macroblock to generate the bitstream 290.

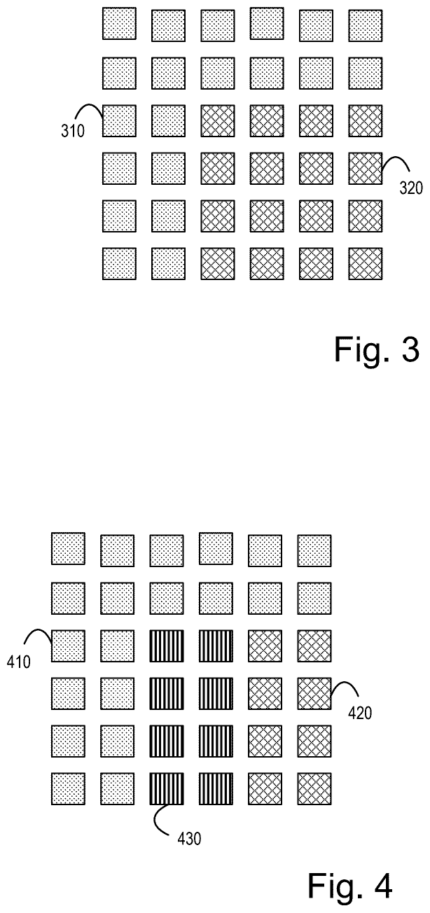

Block prediction, using either inter prediction, intra prediction or a combination thereof, may result in errors and artifacts, especially at the block borders. The presently disclosed systems may leverage deep neural networks to enhance the predicted block, together with its neighboring reconstructed pixels. FIG. 3 provides an example of a 4×4 current predicted block of pixels, shaded as seen in example pixel 320, with an edge of neighboring reconstructed blocks, shaded as seen in example pixel 310. The number of reconstructed pixels may be decided adaptively based on the block size. Alternatively, the number of reconstructed pixels may be inferred at the decoder side by a set rule. For example, for an 8×8 block, the system may use the neighboring 1 horizontal line and 1 vertical line; however for a 32×32 block only 1 line may be insufficient and as such 2 lines may be utilized.

Filtering on the boundaries of current predicted pixels and the neighboring reconstructed pixels may also be employed. This filtering may address blocking artifacts that may occur at these boundaries. Filtering may be various low pass filters, and may even be a filter applied directly to the deblocking module.

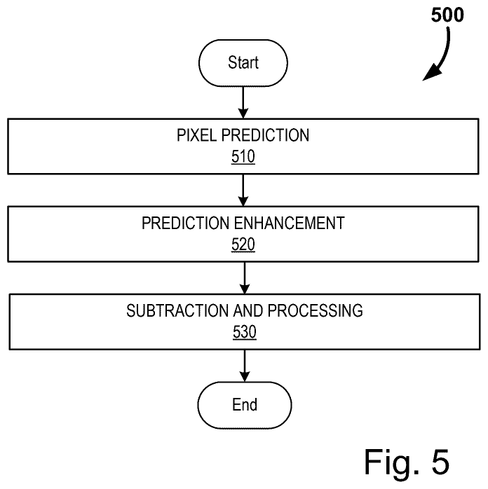

Turning to example illustration of FIG. 4, the current block is further partitioned into smaller parts for prediction. Specifically a current set of prediction blocks as shaded like block 420 are provided, and a second set of prediction blocks as shaded like block 430 are provided. These two sets of prediction blocks constitute, together, the current prediction block, while being neighbored by reconstructed blocks as seen in the shading of block 410. In situations where the predicted block is sub-divided into smaller blocks, the system may also perform filtering on all block boundaries.

In some embodiments, rather than utilizing the reconstructed pixels, the methods and systems may use current pixels to enhance the prediction pixels by feeding current pixel information into a deep neural network. In some embodiments, various different enhancement methods may be predefined, and then selected between based upon the closest match to current pixels and then transmitting the selected method to the decoder. For example, if the difference between the original block and the predicted block is quite large, the system can perform low pass filtering on the predicted block to reduce high frequency energy of the predicted block. Likewise, the system could add some offset on each predicted block to reduce the difference with the original pixels as well (or in the alternative). These offsets are then transmitted to the decoder. The difference between the pixels is a measure of the minimum distortion between the prediction block and the original block. The purpose of transmitting this information to the decoder is that it reduces the computational complexity that the decoder needs to take as compared to if the information was not sent and the decoder were required to derive the information itself, and the information assists the decoder in performing the prediction. The system may also infer the optimal method of enhancing the predicted pixels based on the prediction block's texture. If the predicted texture is quite complex, or if there is high variance, the system may apply weak low pass filters. If the texture is very smooth, in contrast, the system may apply strong low pass filters.

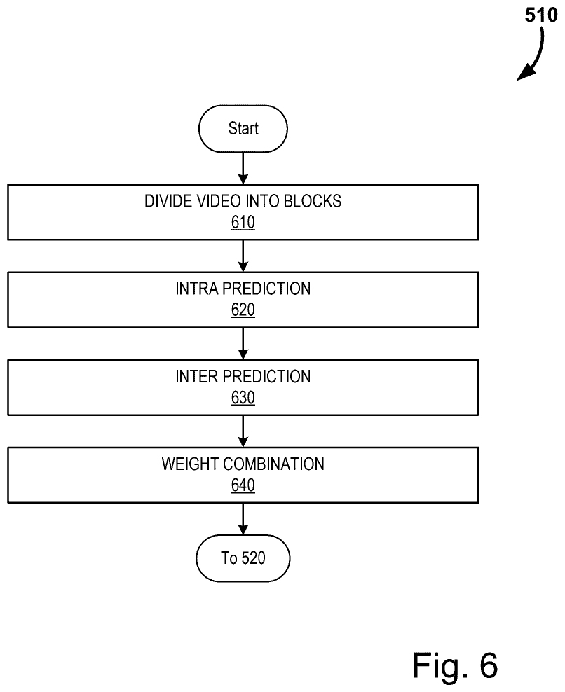

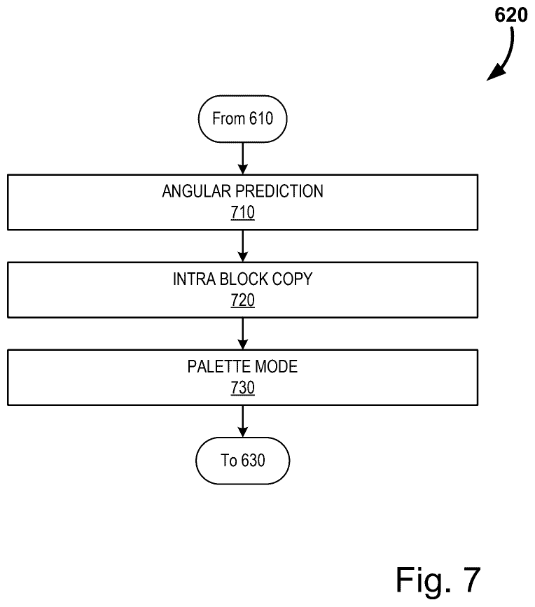

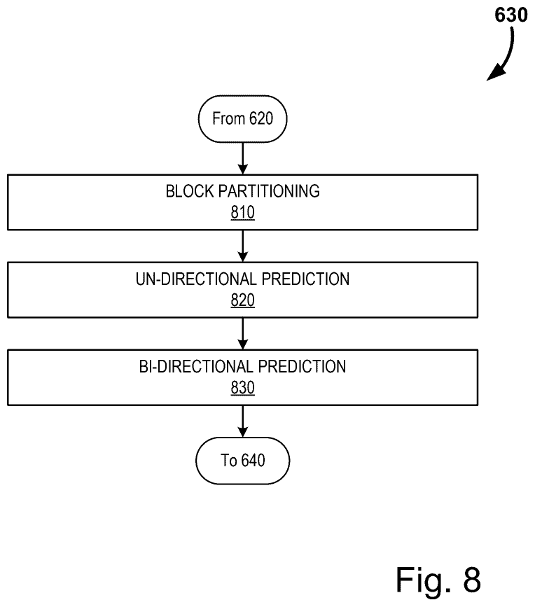

Turning to FIG. 5, an example process is illustrated for the enhanced block prediction, shown generally at 500. Initially the pixel is predicted, at 510, using traditional inter and/or intra prediction techniques. FIG. 6 provides more detail around the pixel prediction sub-process. Initially the video is divided into blocks, a 610, which may be further divided into sub-block regions. Then intra prediction may be performed, in some cases, at 620. Intra prediction uses the reconstructed information in the current frame to predict information of the current block. FIG. 7 provides a greater detailed illustration of the intra-prediction process. Initially the process performs angular prediction at 710. Angular prediction uses neighboring reconstructed pixels to predict the current block. Next the process performs an intra block copy, at 720, which uses a reconstructed block in the previous reconstructed pixels in the same frame, pointed by a motion vector, to predict the current block. Lastly, palette mode is employed at 730. Palette mode generates an index and a color map to predict the current block.

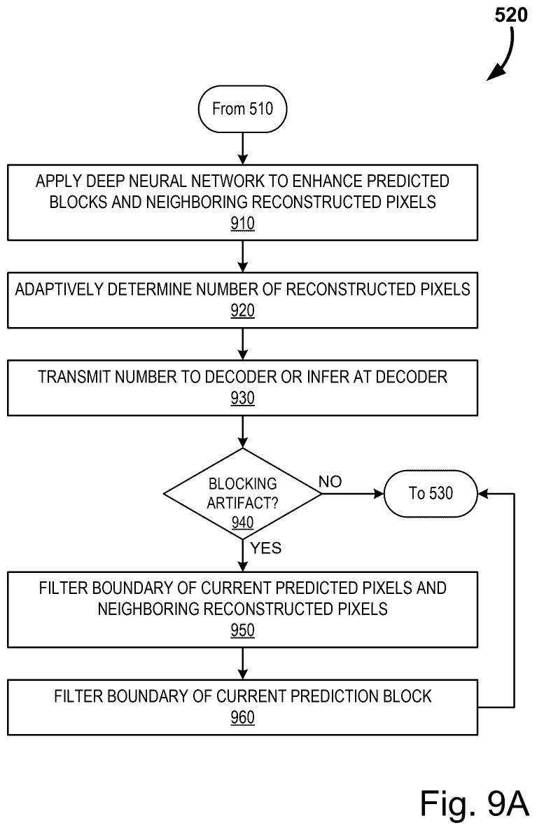

In addition to intra prediction, inter prediction may be employed to predict the current block, at 630 of FIG. 6. FIG. 8 provides a more detailed process of the inter prediction. Initially there is block partitioning, at 810. Block partitioning breaks the blocks into smaller parts, which may be predicted individually. Next the system may perform un-directional prediction, at 820. Un-directional prediction uses one prediction from previous encoded frames to predict the current block, pointed with a motion vector. Lastly, bi-directional prediction may be performed at 830. Bi directional prediction uses two predictions from previous encoded frames to predict the current block, pointed by to motion vectors.

While the present process illustrates both intra and inter predictions occurring in series, it is possible to use either of these prediction techniques alone, or in any combination in order to perform the pixel prediction. When they are utilized together, it is possible to weight the results of their pixel generation and combine these weighted results, at 640. This generates a final set of reconstructed pixels upon which prediction enhancement may be performed, at 520 of FIG. 5.

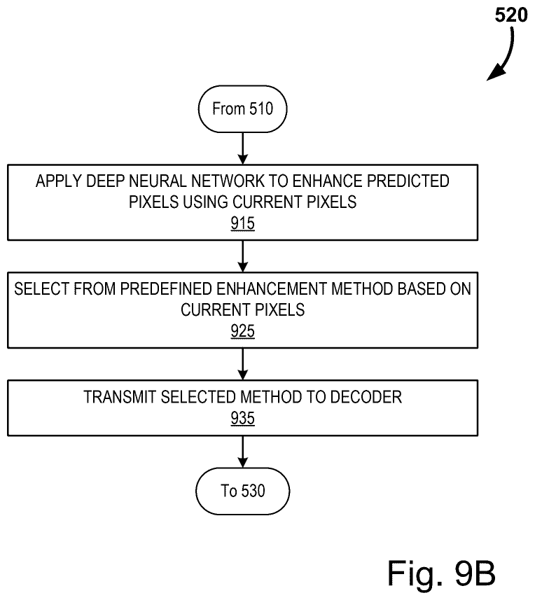

FIG. 9A provides a first more detailed illustration of the prediction enhancement sub-process. Initially, a deep neural network is applied to the predicted blocks and the neighboring reconstructed pixels to enhance the image, at 910. The system may adaptively determine the number of reconstructed pixels, at 920, by a set rule base. This number of reconstructed pixels may be transmitted to the decoder (or may be inferred at the decoder), at 930.

A determination is made if there are edge blocking artifacts, at 940. If not, the process may conclude. But if there are blocking artifacts present, the system may filter the boundaries of the current predicted pixels and the neighboring reconstructed pixels, at 950. Additionally, the boundary of the current prediction block may also be filtered, at 960. This also concludes the enhancement sub-process.

An alternative second sub-process for pixel enhancement is provided in relation to FIG. 9B. This second sub-process is intended to occur instead of the process of FIG. 9A is some embodiments. The sub-process of FIG. 9B begins with the application of the deep neural network to enhance predicted pixels using the current pixels, at 915. The method also selects from a multitude of predefined enhancement methods based upon the current pixels, at 925. The selected method is transmitted to the decoder, at 935, and the sub-process concludes.

Regardless of the sub-process utilized for prediction enhancement, after the enhancement has been concluded, the process returns to FIG. 5 where there is subtraction and processing of the enhancement from the predicted image, at 530. Subtraction and processing may follow standardized video coding steps.

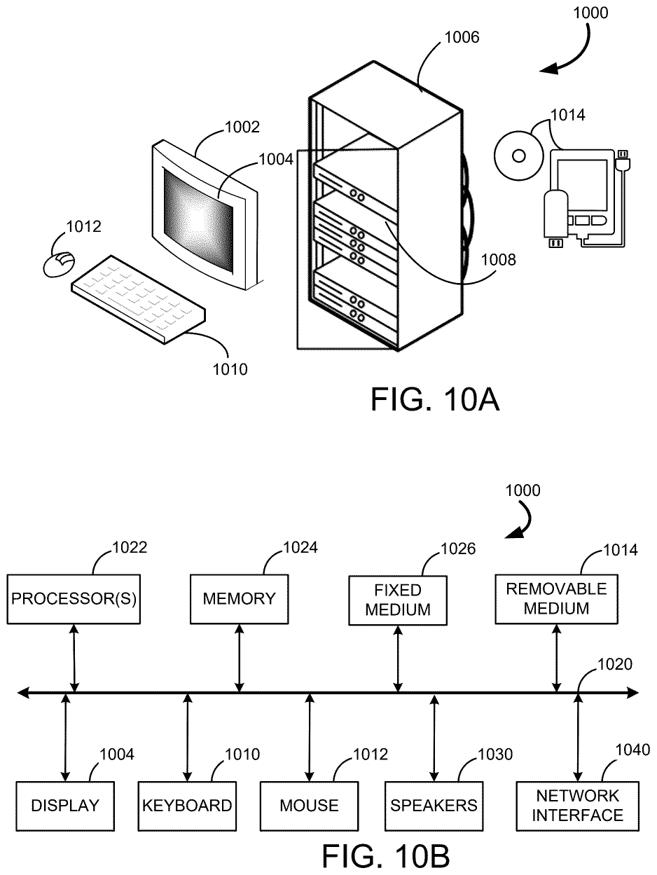

Now that the systems and methods for enhanced block prediction have been provided, attention shall now be focused upon apparatuses capable of executing the above functions in real-time. To facilitate this discussion, FIGS. 10A and 10B illustrate a Computer System 1000, which is suitable for implementing embodiments of the present invention. FIG. 10A shows one possible physical form of the Computer System 1000. Of course, the Computer System 1000 may have many physical forms ranging from a printed circuit board, an integrated circuit, and a small handheld device up to a huge supercomputer. Computer system 1000 may include a Monitor 1002, a Display 1004, a Housing 1006, server blades including one or more storage Drives 1008, a Keyboard 1010, and a Mouse 1012. Medium 1014 is a computer-readable medium used to transfer data to and from Computer System 1000. FIG. 10B is an example of a block diagram for Computer System 1000. Attached to System Bus 1020 are a wide variety of subsystems. Processor(s) 1022 (also referred to as central processing units, or CPUs) are coupled to storage devices, including Memory 1024. Memory 1024 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable form of the computer-readable media described below. A Fixed Medium 1026 may also be coupled bi-directionally to the Processor 1022; it provides additional data storage capacity and may also include any of the computer-readable media described below. Fixed Medium 1026 may be used to store programs, data, and the like and is typically a secondary storage medium (such as a hard disk) that is slower than primary storage. It will be appreciated that the information retained within Fixed Medium 1026 may, in appropriate cases, be incorporated in standard fashion as virtual memory in Memory 1024. Removable Medium 1014 may take the form of any of the computer-readable media described below.

Processor 1022 is also coupled to a variety of input/output devices, such as Display 1004, Keyboard 1010, Mouse 1012 and Speakers 1030. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 1022 optionally may be coupled to another computer or telecommunications network using Network Interface 1040. With such a Network Interface 1040, it is contemplated that the Processor 1022 might receive information from the network, or might output information to the network in the course of performing the above-described enhanced block prediction methods. Furthermore, method embodiments of the present invention may execute solely upon Processor 1022 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 1000 can be controlled by operating system software that includes a file management system, such as a medium operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, Glasses with a processor, Headphones with a processor, Virtual Reality devices, a processor, distributed processors working together, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer (or distributed across computers), and when read and executed by one or more processing units or processors in a computer (or across computers), cause the computer(s) to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

1. A computerized method for intelligent prediction enhancement of a coded video frame comprising:
predicting pixels in a video frame to generate predicted blocks;
applying a deep neural network to enhance prediction of the predicted blocks and neighboring reconstructed pixels;
determining a number of reconstructed pixels adaptively based upon predicted block size;
transmitting the number to a decoder;
subtracting the enhanced prediction from the video frame; and
further processing the enhanced prediction.

2. The method of claim 1, wherein predicting the pixels includes at least one of an inter prediction and an intra prediction.

3. The method of claim 2, further comprising generating a weighted combination of the inter prediction and the intra prediction.

4. The method of claim 1, further comprising determining if there are blocking artifacts present.

5. The method of claim 4, further comprising filtering boundaries of the predicted pixels and the neighboring reconstructed pixels when blocking artifacts are present.

6. The method of claim 5, wherein the filter is a weak low pass filter when the prediction block's texture is complex or if there is a high variance, and wherein the filter is a strong low pass filter when the prediction block's texture is smooth.

7. The method of claim 5, further comprising filtering a boundary of the predicted blocks when blocking artifacts are present.

8. The method of claim 2, wherein intra prediction includes angular prediction, intra block copy and palette mode operation.

9. The method of claim 2, wherein inter prediction includes block partitioning, uni-directional prediction and bi-directional prediction.

10. The method of claim 1, further comprising selecting an enhancement from a predefined set of enhancements based on current pixels and transmitting the selected enhancement to the decoder.

11. A computerized system for intelligent prediction enhancement of a coded video frame comprising:
a processing unit for predicting pixels in a video frame to generate predicted blocks;
a server for applying a deep neural network to enhance prediction of the predicted blocks and neighboring reconstructed pixels, determining a number of reconstructed pixels adaptively based upon predicted block size, and transmitting the number to a decoder; and
the decoder for subtracting the enhanced prediction from the video frame, and further processing the enhanced prediction.

12. The system of claim 11, wherein predicting the pixels includes at least one of an inter prediction and an intra prediction.

13. The system of claim 12, wherein the predicting the pixels further comprises generating a weighted combination of the inter prediction and the intra prediction.

14. The system of claim 11, wherein the server is further configured to determine if there are blocking artifacts present.

15. The system of claim 14, wherein the server is further configured to filter boundaries of the predicted pixels and the neighboring reconstructed pixels when blocking artifacts are present.

16. The system of claim 15, wherein the filter is a weak low pass filter when the prediction block's texture is complex or if there is a high variance, and wherein the filter is a strong low pass filter when the prediction block's texture is smooth.

17. The system of claim 15, wherein the server is further configured to filter a boundary of the predicted blocks when blocking artifacts are present.

18. The system of claim 12, wherein intra prediction includes angular prediction, intra block copy and palette mode operation.

19. The system of claim 12, wherein inter prediction includes block partitioning, uni-directional prediction and bi-directional prediction.

20. The system of claim 11, wherein the server is further configured to select an enhancement from a predefined set of enhancements based on current pixels and transmitting the selected enhancement to a decoder.
